(19) United States
(12) Patent Application Publication
(10) Pub. No.: US 2020/0373804 A1
(43) Pub. Date: Nov. 26, 2020

(54) FAN WATERPROOF STRUCTURE

(71) Applicant: ASIA VITAL COMPONENTS (CHINA) CO., LTD., Shenzhen (CN)

(72) Inventors: Chu-Hsien Chou, Shenzhen (CN); Sung-Wei Sun, Shenzhen (CN)

(21) Appl. No.: 16/420,173

(22) Filed: May 23, 2019

(51) Int. Cl. H02K 5/10; H02K 7/14; F04D 25/06; F04D 19/00; F04D 29/02; F04D 29/52

(52) U.S. Cl. CPC H02K 5/10; H02K 7/14; F04D 25/0606; F05B 2240/14; F04D 29/023; F04D 29/522; F04D 19/002

(57) ABSTRACT

A fan waterproof structure includes a frame body and a stator assembly. The frame body has a base seat and a circumferential wall. Multiple first support members horizontally extend from the base seat to connect with the circumferential wall. The stator assembly is disposed on the base seat and has an electrical wire. A waterproof plastic layer is disposed on the stator assembly to enclose the stator assembly. A second support member horizontally extends from the waterproof plastic layer to connect with the circumferential wall. The electrical wire is disposed in the second support member to achieve good waterproof effect.

### BACKGROUND OF THE INVENTION

### 1. Field of the Invention

The present invention relates generally to the fan field, and more particularly to a fan waterproof structure.

### 2. Description of the Related Art

It is known that a fan motor is often used in a severe working environment, for example, a high-humidity dusty environment or salt-mist environment. In such working environment, the stator of a common fan is apt to damage to cause malfunction of the fan.

Recently, some manufacturers have developed improved fan structure to overcome the severe working environment. Please refer to FIG. 1, which is a perspective sectional view of the conventional fan waterproof structure. The current method is to form a waterproof plastic layer 91 by means of plastic potting or insert integral injection so as to enclose the entire stator assembly 9, whereby the stator assembly 9 is isolated from the outer environment.

However, the current method has some problems as follows:
1. The waterproof plastic layer 91 encloses the entire stator assembly 9. The electrical wire outward extends from the circuit board 94 in the stator assembly 9 and the main body of the electrical wire is exposed to outer side of the waterproof plastic layer 91. That is, only a small part of the electrical wire is enclosed in the waterproof plastic layer 91. In practice, when pulling the electrical wire, the waterproof plastic layer 91 is apt to break off. As a result, the humidity is easy to infiltrate into the stator assembly 9 to cause damage.
2. One of the ribs or the static blades is formed with a half-open receiving channel 97. After the main body of the electrical wire of the stator assembly 9 is conducted through an opening 96 of the base seat, the main body of the electrical wire is received in the receiving channel 97. The electrical wire is restricted by the original structure of the rib 93 (or static blade) of the base seat 92 so that the electrical wire is apt to be over-pulled. As a result, the wire outlet 95 of the waterproof plastic layer 91 is easy to break off or the electrical wire is over-pulled to break off.

It is therefore tried by the applicant to provide a fan waterproof structure to solve the problems existing in the conventional structure.

### SUMMARY OF THE INVENTION

It is therefore a primary object of the present invention to provide a fan waterproof structure with good waterproof effect.

It is a further object of the present invention to provide the above fan waterproof structure, which is able to effectively lower the possibility of breakage of the electrical wire.

To achieve the above and other objects, the fan waterproof structure of the present invention includes a frame body and a stator assembly. The frame body has a base seat and a circumferential wall. Multiple first support members horizontally extend from the base seat to connect with the circumferential wall. The stator assembly is disposed on the base seat and has an electrical wire. A waterproof plastic layer is disposed on the stator assembly to enclose the stator assembly. A second support member horizontally extends from the waterproof plastic layer to connect with the circumferential wall. The electrical wire is disposed in the second support member.

According to the above arrangement, the first support members and the second support member form a complete rib structure or static blade structure. The electrical wire is entirely enclosed in the second support member to achieve good waterproof effect. Also, when assembled, the electrical wire is prevented from being over-pulled.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of the conventional fan waterproof structure;

FIG. 2A is a perspective exploded view of the fan waterproof structure of the present invention;

FIG. 2B is a perspective assembled view of the fan waterproof structure of the present invention;

FIG. 3A is a top view of the frame body of the present invention;

FIG. 3B is a top view of the stator assembly of the present invention; and

FIG. 4 is a perspective exploded view of the fan employing the fan waterproof structure of the present invention.

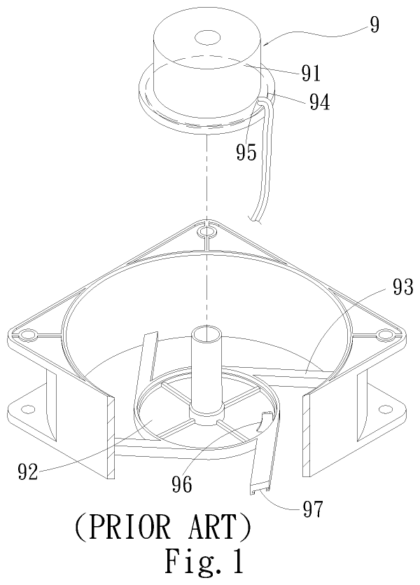

### DETAILED DESCRIPTION OF THE PREFERRED EMBODIMENTS

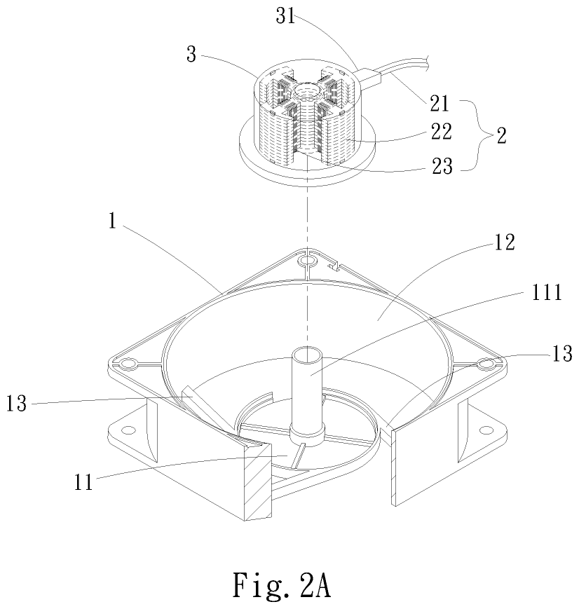

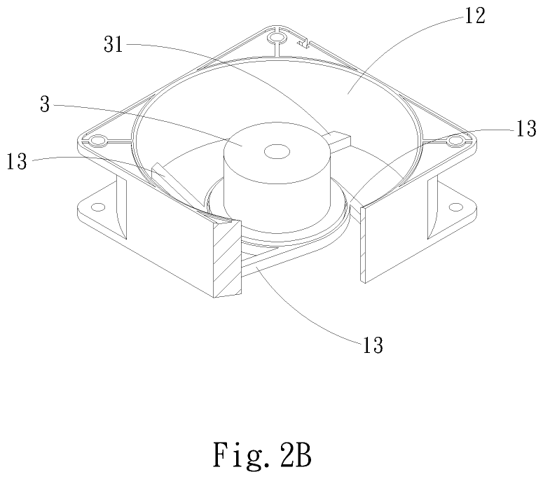

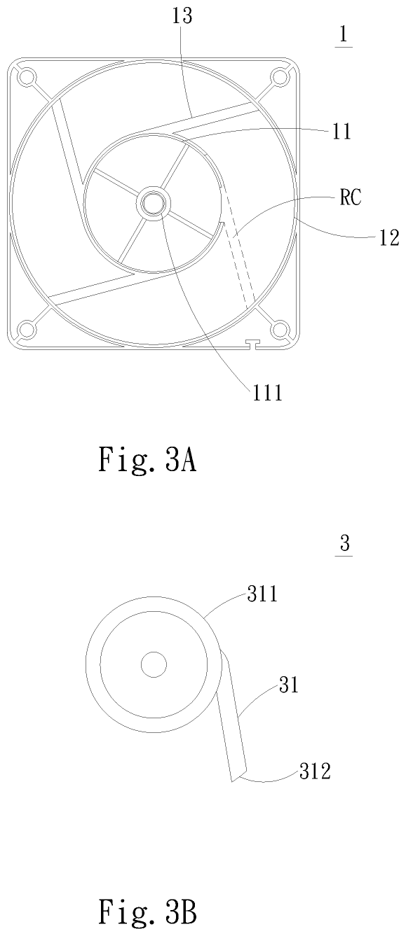

Please refer to FIGS. 2A, 2B, 3A and 3B. FIG. 2A is a perspective exploded view of the fan waterproof structure of the present invention. FIG. 2B is a perspective assembled view of the fan waterproof structure of the present invention. FIG. 3A is a top view of the frame body of the present invention. FIG. 3B is a top view of the stator assembly of the present invention. In the fan waterproof structure of the present invention, the frame body 1, the stator assembly 2 and the waterproof plastic layer 3 are changed so as to enhance the waterproof effect of the electrical wire 21 in adjacency to the stator assembly 2 and solve the problem that when pulling the electrical wire 21, the electrical wire 21 is apt to break off.

The frame body 1 includes a base seat 11 and a circumferential wall 12. Multiple first support members 13 horizontally extend from the base seat 11 to connect with the circumferential wall 12. A bearing cup 111 is vertically disposed at the center of the base seat 11. The stator assembly 2 is fitted around the bearing cup 111. The first support members 13 can be ribs or static blades.

The stator assembly 2 has an electrical wire 21, an iron core 22 and a winding 23. The iron core 22 is such as, but not limited to, composed of multiple stacked silicon steel sheets. The winding 23 is wound around the iron core 22. The electrical wire 21 is connected with the winding 23.

The waterproof plastic layer 3 is disposed on the stator assembly 2 to enclose the electrical wire 21, the iron core 22 and the winding 23. A second support member 31 horizontally extends from the waterproof plastic layer 3 to connect with the circumferential wall 12. The electrical wire 21 is disposed in the second support member 31. The waterproof plastic layer 3 is made by means of plastic potting or low-pressure insert integral injection. The second support member 31 can be a rib or a static blade.

The second support member 31 has a first end 311 and a second end 312. The first end 311 is connected with the waterproof plastic layer 3. The second end 312 is connected with the circumferential wall 12.

Please refer to FIGS. 3A and 3B. It can be clearly seen from FIG. 3A that the first support members 13 of the frame body 1 are not arranged at equal intervals. A larger open space is formed on the right side, which is defined as a reserved assembling section RC. It can be seen from FIG. 3B that the second support member 31 of the waterproof plastic layer 3 corresponds to the open space. When the stator assembly 2 is disposed on the bearing cup 111, the second support member 31 is positioned in the reserved assembling section RC. Accordingly, the first support members 13 and the second support member 31 will form a complete rib structure or static blade structure. In this embodiment, there are three first support members 13. However, in practice, the number of the first support members 13 is not limited to three. The number of the first support members 13 can be freely increased or decreased according to the requirement of actual use.

In consideration of easy manufacturing and structural strength, the second support member 31 and the waterproof plastic layer 3 can be made of same material or different materials. Also, in consideration of the strength of the entire structure and easy manufacturing, the first support members 13 and the second support member 31 can be made of same material or different materials. The material is such as, but not limited to, polypropylene (PP), ABS resin, polybutylene terephthalate (PBT) or the like material. In case of different materials, due to different properties of the materials, the vibration frequencies of the materials are totally different from each other so that the co-vibration and the noise can be greatly lowered.

In short, in the present invention, the distance between the outlet for the electrical wire 21 and the interior of the stator assembly 2 is greatly increased so that the waterproof effect is enhanced to solve the problem of the conventional structure that the waterproof plastic layer is apt to break off and lose its waterproof function. In addition, the structure of the present invention improves the shortcoming of the conventional structure that when assembled and wired, the electrical wire 21 is often over-bent and broken off.

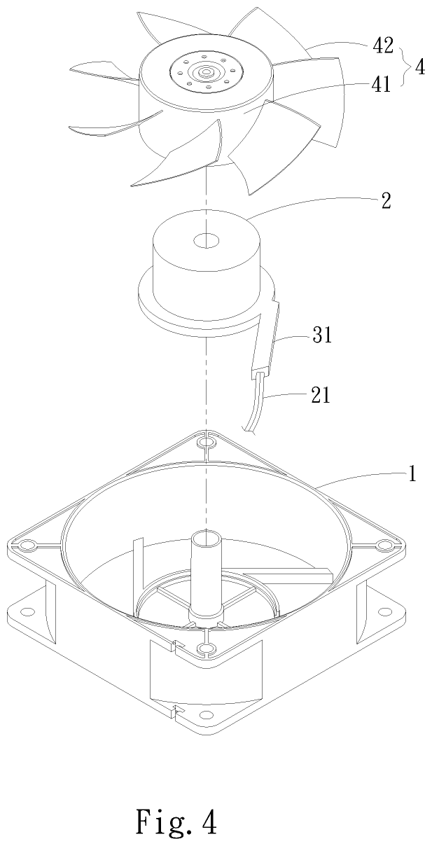

Please refer to FIG. 4, which is a perspective exploded view of the fan employing the fan waterproof structure of the present invention. Also, referring to FIGS. 2A, 2B, 3A and 3B, the stator assembly 2 is first assembled with the frame body 1. Then the rotor assembly 4 is inserted into the stator assembly 2. The rotor assembly 4 has a shaft (not shown), a hub 41 and multiple blades 42 disposed on the hub 41. When the stator assembly 2 is powered on, the stator assembly 2 will drive the rotor assembly 4 to rotate. The blades 42 are rotated to create airflow.

In conclusion, the present invention has the following advantages:
1. The present invention has good waterproof effect.
2. The present invention solves the problem that when pulling the electrical wire, the electrical wire is apt to break off.
3. The present invention solves the problem that the waterproof plastic layer is apt to break off.
4. The present invention is able to lower the co-vibration and noise.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A fan waterproof structure comprising:
a frame body having a base seat and a circumferential wall, multiple first support members horizontally extending from the base seat to connect with the circumferential wall; and
a stator assembly having an electrical wire, the stator assembly being disposed on the base seat, a waterproof plastic layer being disposed on the stator assembly to enclose the stator assembly, a second support member horizontally extending from the waterproof plastic layer to connect with the circumferential wall, the electrical wire being disposed in the second support member.

2. The fan waterproof structure as claimed in claim 1, wherein a bearing cup is vertically disposed at a center of the base seat, the stator assembly being fitted around the bearing cup.

3. The fan waterproof structure as claimed in claim 1, wherein the first support members are ribs or static blades.

4. The fan waterproof structure as claimed in claim 1, wherein the second support member is a rib or a static blade.

5. The fan waterproof structure as claimed in claim 1, wherein the first support members and the second support member form a complete rib structure or static blade structure.

6. The fan waterproof structure as claimed in claim 1, wherein the waterproof plastic layer is made by means of plastic potting or low-pressure insert integral injection.

7. The fan waterproof structure as claimed in claim 1, wherein the first support members and the second support member are made of same material or different materials.

8. The fan waterproof structure as claimed in claim 1, wherein the second support member and the waterproof plastic layer are made of same material or different materials.

9. The fan waterproof structure as claimed in claim 1, wherein the second support member has a first end and a second end, the first end being connected with the waterproof plastic layer, the second end being connected with the circumferential wall.
